(19) United States
(12) Patent Application Publication
(10) Pub. No.: US 2005/0013901 A1
(43) Pub. Date: Jan. 20, 2005

(54) Distillers solubles as a constituent for nisin and lactic acid production from dairy cheese by products

(76) Inventors: Richard W. Glass, Maryland Heights, MO (US); Tracy Aurora Christine Snider, Chesterfield, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/867,343

(22) Filed: Jun. 14, 2004

Related U.S. Application Data
(60) Provisional application No. 60/478,554, filed on Jun. 13, 2003.

(51) Int. Cl. A23C 9/12

(52) U.S. Cl. 426/41

(57) ABSTRACT

This invention is a method for utilizing the output of ethanol production by using the condensed distillers solubles (CDS) by-product from ethanol production as a source of high nitrogen and phosphorus for fermentation of whey and whey permeate to produce nisin and lactic acid.

### CROSS-REFERENCE TO RELATED APPLICATIONS

This application claims the benefit of U.S. provisional application No. 60/478,554 filed Jun. 13, 2003.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to whey fermentation and, more particularly, to a method for using the by-products of ethanol production to enhance whey fermentation to produce nisin and lactic acid.

2. Related Art

Methods of producing either nisin or lactic acid are generally known. Nisin is a highly modified peptide antibiotic that is commonly used as a natural food preservative. Lactic acid is a raw material for biopolymer production.

It is also generally known to produce nisin and lactic acid simultaneously by the fermentation of whey and whey permeate. For example, in an oral presentation given on May 6, 2003, at the “Symposium on Biotechnology for Fuels and Chemicals” at Breckenridge, Colo., entitled “Nisin and Lactic Acid Simultaneous Production from Cheese Industry Byproduct: Optimization of Fermentation Conditions Through Statistically Based Experimental Designs”, by Chuanbin Liu, Yan Liu, Wei Liao, Zhiyou Wen, Dongmei Wang, and Shulin Chen, a biorefinery process which utilizes cheese industry by-products as substrates to simultaneously produce nisin and lactic acid was disclosed. Moreover, in Applied Biochemistry and Biotechnology, Spring 2004, Volume 114, issue 1-3, pps. 627-638 entitled “25^{th} Symposium on Biotechnology for Fuels and Chemicals, by Chaunabin Liu, Yan Liu, Wei Lioa, Zhiyou Wen, and Shulin Chen, the method of using cheese whey in the production of nisin and lactic acid is also disclosed.

It is also generally known that the production of nisin and lactic acid by fermentation of whey and whey permeate requires a high input of nitrogen and phosphorus. For example, in the above-referenced oral presentation given on May 6, 2003, the requirement for a high amount of nitrogen and phosphorus for the fermentation of whey and whey permeates into nisin and lactic acid was disclosed.

The requirement of nitrogen and phosphorus adds significant costs to the production of nisin and lactic acid. Current sources of nitrogen and phosphorus include yeast extract, which is a costly ingredient.

It is generally known that corn may be used to produce ethanol using a process in which corn is fermented to produce ethanol and spent mash. The spent mash in turn yields wet distillers grains, condensed distillers solubles (CDS), distillers dried grains (DDG), and distillers dried grains with solubles (DDGS). DDGS is a complex nitrogenous material containing a high concentration of phosphorus. Therefore, it is generally known that the by-products of the ethanol production process include nitrogen and phosphorus.

### SUMMARY OF THE INVENTION

An aspect of the present invention is to provide a method for utilizing the output of ethanol production by using a distillers solubles by-product from ethanol production as a source of nitrogen and phosphorus for fermentation of whey and whey permeate to produce nisin and lactic acid.

Another aspect of the present invention is to provide a method of producing nisin and lactic acid from cheese by-products by using distillers solubles as a constituent.

Another aspect of the present invention is to provide a reduction in the cost of producing nisin and lactic acid with the use of distillers solubles as the phosphorus and nitrogen source.

In accordance with one or more of the above aspects of the invention, there is provided a method for utilizing the output of ethanol production using the DDGS by-product from ethanol production as a source of nitrogen and phosphorus for fermentation of whey and whey permeate to produce nisin and lactic acid. In one embodiment, the method includes utilizing corn for ethanol production and its by-products.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

The accompanying drawings, which are incorporated in and form a part of the specification, illustrate the useful embodiments of the present invention and together with the description, serve to explain the principles of the invention. In the drawings:

FIG. 1 illustrates a block diagram of the process of producing distillers solubles through ethanol distillation.

FIG. 2 illustrates a block diagram of the process of producing whey.

FIG. 3 illustrates the composition of the medium for the production of whey.

FIG. 4 illustrates a block diagram of one embodiment of the process of the present invention, nisin and lactic acid production through whey fermentation with the use of distillers solubles.

### DETAILED DESCRIPTION OF THE PREFERRED EMBODIMENTS

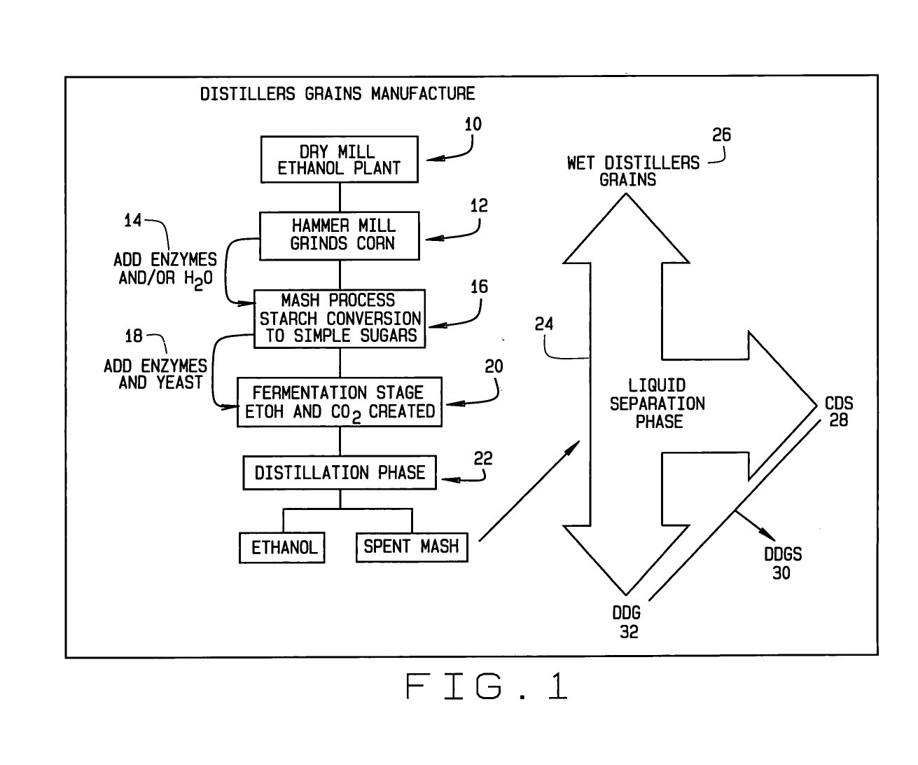

Referring to the accompanying drawings in which like reference numbers indicate like elements, FIG. 1 illustrates the production of distillers solubles wherein corn or other grains are fermented producing ethanol and spent mash. Corn is fermented at a dry mill ethanol plant 10. In the first step 12, the hammer mill grinds the corn. In the second step 14, enzymes or water are added to the ground corn. In the third step 16, the mash process, the starch is converted to simple sugars. In the fourth step 18, enzymes or yeast are added. In the next step, 20, the fermentation stage, ethanol and carbon dioxide are created. In the next step 22, the distillation phase, ethanol and the fermentation by-product, spent mash, are separated. In the final step of the production of distillers grains, the liquid separation phase 24, the spent mash yields wet distillers grains 26, condensed distillers solubles (CDS) 28, and distillers dried grains with solubles (DDGS) 30, and distillers dried grains (DDG) 32. The distillers dried grains with solubles (DDGS) contain a high concentration of phosphorus and nitrogen.

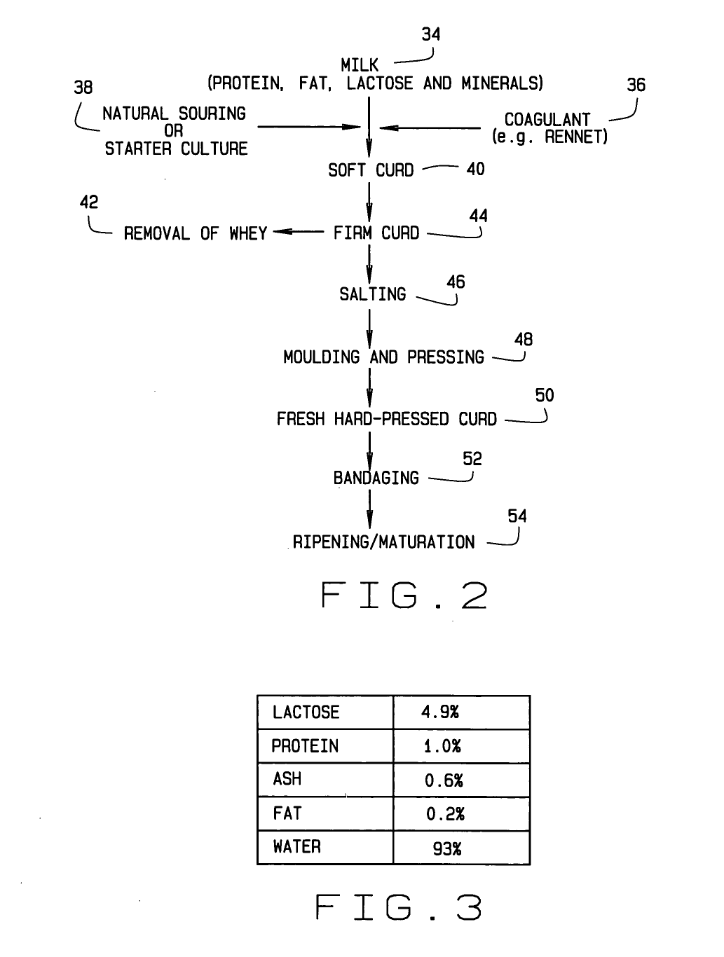

FIG. 2 illustrates a process in which whey and whey permeate are produced as a by-product in the production of cheese. Preferably, the production of cheese begins with a milk medium 34 that comprises lactose protein, ash, fat and water. As illustrated in FIG. 3, the medium preferably comprises: 4.9% lactose, 1.0% protein, 0.6% ash 0.2% fat, and 93% water. The next step of this process includes addition of a coagulant to the medium 36. The coagulant may be virtually any coagulant, including but not limited to rennet. The next step includes natural souring or adding a starter culture to the medium 38. A soft curd 40 is produced from the natural souring or addition of the starter culture. In the next step, whey and whey permeate is removed 42 from the soft curd which may then be used in the production of nisin and lactic acid. The step of removing whey converts the soft curd into firm curd 44. FIG. 2 also illustrates the final steps in the production of cheese which include: salting 46, molding and pressing 48 (producing fresh hard-pressed curd 50), bandaging 52, and ripening and maturing 54.

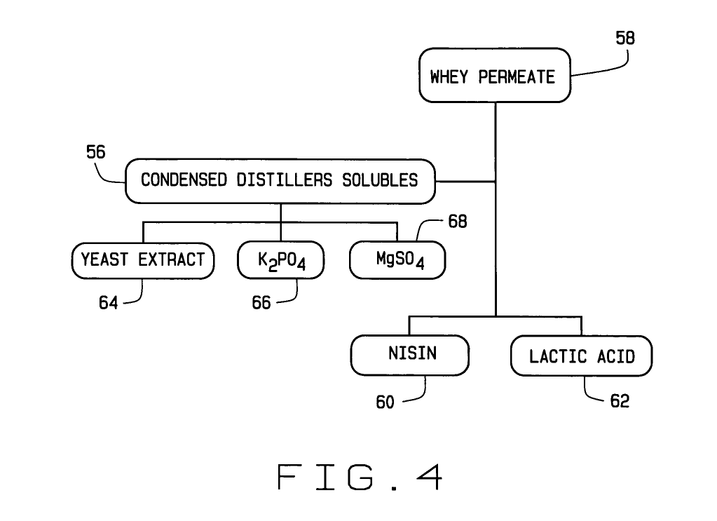

FIG. 4 illustrates the method of producing nisin and lactic acid in which condensed distillers solubles are used as a constituent in whey fermentation. The method involves the inclusion of condensed distillers solubles 56 as a constituent in the fermentation of whey or whey permeate 58 in the production of nisin 60 and lactic acid 62. The method also includes adding yeast extract 64, K(2)PO(4) 66, and MgSO(4) 68 to the condensed distillers solubles 56. The condensed distillers solubles 56 provide the nitrogen and phosphorus source for the production of nisin and lactic acid. The condensed distillers solubles 56 replace the use of yeast extract, the source of nitrogen and phosphorus in known methods of lactic acid and nisin production. The condensed distillers solubles 56 have been analyzed and shown to have 28.7% solids. Of the 28.7% solids, the total nitrogen is 1.2%. In the first trial the condensed distillers solubles 56 performed at 75% the value of yeast extract with only 5% inclusion rates.

A preliminary study has been conducted at Washington State University in order to prove the concept of using distillers solubles as a nutrient supplement for nisin and lactic acid simultaneous production from cheese whey. In the preliminary study, the raw material, condensed distillers solubles (CDS), was characterized, and the first bench of fermentation test was conducted.

1. Characterization of Distillers Solubles

The composition information of condensed distillers solubles (CDS) was analyzed. This information is essential for the following steps of medium optimization study. Total nitrogen, ammonia, phosphorous, protein, and amino acid profile of distillers solubles was analyzed using standard methods. The content of the major ethanol fermentation by-products including lactate and acetate, which may have negative effects on bacteria metabolism, was also analyzed. The results are shown in Table 1.

TABLE 1
Characterization of Corn/Milo Condensed Distillers
Solubles (CDS) form High Plains Corporation

| Parameter | Value |
|---|---|
| Total Solids | 28.70% |
| Water | 71.30% |
| Total Nitrogen | 1.20% |
| Total Phosphorous | 0.31% |
| Crude Protein | 7.50% |
| Water soluble peptides and amino acids | 3.16% |
| Ammonia | 0.11% |
| Lactate | 2.40% |
| Acetate | 0.15% |

Because the purpose of the preliminary study was to verify the feasibility of using distillers solubles as a nutrient supplement for nisin and lactic acid simultaneous production from cheese whey, the nitrogen and protein content was especially studied. The results in Table 1 indicate that, CDS has 7.50% crude protein, but only 42% of the protein is water soluble. The content of ammonia in CDS is very low, only 0.11%, and it only contributes to 8.6 percent of the total nitrogen.

Table 2 presents the content of water soluble peptides and amino acids in the most commonly used nutrient supplements for microbe growth or fermentation. One can easily see that, water soluble protein account to about half of the dry weight of yeast extract or peptone. However, there is only 11% of water soluble protein in CDS (dry base). Compared with the total protein content (26.1%), more than half of protein in CDS is not water soluble.

TABLE 2
Water soluble amino acids in different
nutrient supplements (dry base)

| Nutrient | Yeast | Peptone from | Peptone | Corn distillers |
|---|---|---|---|---|
| supplement | extract | soybean | from meat | solubles |
| Water soluble | 48% | 49% | 47% | 11% |
| peptides and | | | | |
| amino acids | | | | |

The significant difference in water soluble peptides and amino acids and their is due to the difference in the technologies of how each is produced. Yeast extract is the autolysis product of yeast cells. The macromolecules, such as protein, have been degraded into small peptides. Therefore, the solubility of yeast extract is very good. Similarly, peptone is also a mixture of enzyme hydrolyzed protein. However, during the preparation of CDS, yeast cells in it have no time to autolyze before they are killed by heat. So only part of the protein of the yeast becomes water soluble. Considering the solubility of protein in CDS, further treatment of CDS may generate more peptides that are ready to be dissolved in water.

2. Fermentation Study

2.1. CDS Alone as the Nutrient Supplement

In order to quantify the performance of CDS, the optimal medium for nisin and lactic acid co-production obtained in an earlier study was used as positive control, and the whey without any nutrient added was used as negative control. CaCO₃ was provided to maintain the fermentation pH around 5.5. The biomass, nisin biosynthesis, and lactic acid formation after 24 hours of fermentation were compared. As shown in Diagram 1, the production of nisin was very poor when bacteria grew on whey without the addition of any nutrient, and a significant increase (2 fold) of nisin formation was seen when 5% of CDS (wet base) was added, although it is only 70% of that at the earlier optimized conditions. Therefore, it can be concluded that CDS does able to provide essential nutrients for nisin production from whey.

2.2. Effects of Nutrient Supplements on Nisin and Lactic Acid Production

Considering that the nisin producing strain L. lactis is a well-known nutritionally fastidious microorganism requiring an abundance of nutrients for cell growth and metabolism, and CDS alone may not provide all essential nutrients for the growth and the metabolism of L. lactis, additional nutrients were required for the simultaneous production of nisin and lactic acid. Yeast extract (YE), peptone from meat (PM), and peptone from soy (PS), the most widely used organic nutrient supplements in fermentation studies, as well as KH₂PO₄ were selected as the candidates for nutrient supplement. The stimulation effects of these nutrient supplements on cell growth, nisin formation, and lactic acid production were studied. In addition to 5% of CDS, YE, PS, PM, and KH₂PO₄ were added in media. The fermentation results are compared in Diagram 2.

Yeast extract and peptone, as seen by the comparative yields with the control, are ideal sources of nutrient for nisin and lactic acid co-production. KH₂PO₄ is essential, as the yield of nisin and lactic acid was around 80% of the control. The combination of KH₂PO₄ and YE gave the highest yield of nisin and lactic acid.

[image]

[image]

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A method for utilizing the output of ethanol production, comprising:
obtaining a distillers by-product from ethanol production; and
using the by-product as a source of nitrogen and phosphorus for fermenting whey and whey permeate thereby producing nisin and lactic acid.

2. The method according to claim 1 wherein the step of obtaining the distillers by-product includes obtaining a distillers by-product formed of dried grains with solubles

3. The method according to claim 1 wherein the distillers by-product has a high concentration of phosphorus.

4. The method according to claim 1 wherein the ethanol production from which the distillers by-product is obtained includes a carbohydrate source which is selected from the group consisting of corn, wheat, biomass, wood, waste paper, manure, cheese whey, molasses sugar beets and sugar cane.

5. The method according to claim 1 wherein said distillers by-product comprises 28.7% solids.

6. The method according to claim 1 wherein said distillers by-product comprises 1.2% nitrogen.

7. The method according to claim 1 wherein said distillers by-products are included at a 5% rate.

8. A method of producing nisin and lactic acid, comprising the steps of:
fermenting carbohydrate to chemically convert the carbohydrate to ethanol, wherein said step of fermenting carbohydrate further yields a distillers by-product;
fermenting whey to chemically convert whey to nisin and lactic acid wherein said step of fermenting whey uses said distillers by-product as a source of nitrogen and phosphorus.

9. A method according to claim 8 wherein said distillers by-product is a distillers dried grains with solubles by-product.

10. The method according to claim 8 wherein said distillers by-product comprises 28.7% solids.

11. The method according to claim 8 wherein said distillers by-product comprises 1.2% nitrogen.

12. The method according to claim 5 wherein said distillers by-products are included at a 5% rate.

13. A method of producing nisin and lactic acid, comprising:
obtaining a distillers by-product from ethanol production; and
using the distillers by-product as a source of nitrogen and phosphorus for fermenting whey and whey permeate to produce nisin and lactic acid.

14. The method according to claim 13 wherein step of obtaining the distillers by-product includes obtaining a distillers by-product formed of dried grains with solubles.

15. The method according to claim 13 wherein the distillers by-product comprises 28.7% solids.

16. The method according to claim 13 wherein the distillers by-product comprises 1.2% nitrogen.

17. The method according to claim 13 wherein the distillers by-products are included at a 5% rate.
